(19) United States
(12) Patent Application Publication
(10) Pub. No.: US 2008/0090920 A1
(43) Pub. Date: Apr. 17, 2008

(54) FLAME RETARDANT EXTRUDED POLYSTYRENE FOAM COMPOSITIONS

(75) Inventor: Kimberly A. Maxwell, Baton Rouge, LA (US)

Correspondence Address: EDGAR SPIELMAN;ALBEMARLE CORPORATION, 451 FLORIDA BLVD., BATON ROUGE, LA, 70801, US

(73) Assignee: Albemarle Corporation, Baton Rouge, LA (US)

(21) Appl. No.: 11/861,459

(22) Filed: Sep. 26, 2007

Related U.S. Application Data
(63) Continuation-in-part of application No. 11/722,463, filed on Jun. 21, 2007.
(60) Provisional application No. 60/827,020, filed on Sep. 26, 2006.

(51) Int. Cl. C08K 5/3417; C08G 18/00

(52) U.S. Cl. 521/79; 521/155

(57) ABSTRACT

Extrudable polystyrene foam compositions having flame retardant properties, flame retarded extruded polystyrene foams, methods of making such foams, and products comprising such compositions and foams are provided. The extrudable polystyrene compositions having flame retardant compositions can be generally characterized as having a molecular weight (M_{W})of at least about 90% of the polystyrene in an identical composition without the flame retardant compound and a Yellowness Index in the range of from about 1 to about 10.

### CROSS REFERENCE TO RELATED APPLICATION

This application claims priority to U.S. patent application Ser. No. 11/722,463 and U.S. patent application Ser. No. 60/827,020 and is a continuation-in-part of U.S. patent application Ser. No. 11/722,463 filed on Dec. 22, 2004, and U.S. patent application Ser. No. 60/827,020 filed on Sep. 26, 2006.

### FIELD OF THE INVENTION

The present invention relates to extruded polystyrene foams.

### BACKGROUND OF THE INVENTION

Styrenic polymer compositions and foams, such as extruded polystyrene foam, are used widely in the manufacture of extruded articles, paints, film coatings, and miscellaneous products. Extruded polystyrene foam is characterized by fully closed cells that provide superior insulative properties and high compressive strength.

Extruded polystyrene foam typically is made by blending a styrenic polymer, a flame retardant compound, and a blowing agent, and extruding the resultant mixture through a die to form the foam. For some product applications, it is desirable to decrease the flammability of extruded polystyrene foams through the use of flame retardant compounds. Flame retardant compounds for use in extruded polystyrene foams have many requirements, including thermal stability, substantial miscibility in polystyrene, and high flame retardancy. Further, in some applications it is also desirable that these flame retardant compounds do not discolor the foam, i.e. the color of the foam containing the flame retardant compound is as close to the color of a foam without the flame retardant compound as possible.

Thus, there is a need for a flame retardant compound that meets some, if not all, of the above requirements.

### SUMMARY OF THE INVENTION

The present invention is directed generally to a flame-retarded extruded polystyrene foam having an average YI in the range of from about 1 to about 10, the foam containing as a flame retardant, a compound having the structure:

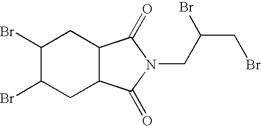

The foam may be formed from a composition having an initial shear viscosity that decreases less than about 15% after about 32 minutes at 190° C. In one aspect, the foam may be formed from a composition having an initial shear viscosity that decreases less than about 10% after about 32 minutes at 175° C.

The foam may be formed from a composition in which the polystyrene has a molecular weight (M_{W}) of at least about 90% of the polystyrene in an identical composition without the flame retardant compound. In another aspect, the foam may be formed from a composition in which the polystyrene has a molecular weight (M_{W}) of at least about 95% of the polystyrene in an identical composition without the flame retardant compound.

Foams of the present invention have an average YI in the range of from about 1 to about 10, preferably in the range of from about 1 to about 5, more preferably in the range of from about 1 to about 3, most preferably in the range of from about 1 to about 2, and in exemplary embodiments, the foam has an average YI of 1.

The extruded polystyrene foam may be used to form an article of manufacture. For example, the extruded polystyrene foam may be used to form thermal insulation.

According to another aspect of the invention, a flame-retarded extruded polystyrene foam contains a flame retardant compound, where the foam has an average YI in the range of from about 1 to about 10 and at least on of the following characteristics:
(a) the foam is formed from a composition having an initial shear viscosity that decreases less than about 15% after about 32 minutes at 190° C.
(b) the foam is formed from a composition having an initial shear viscosity that decreases less that about 10% after about 32 minutes at 175° C.; and/or
(c) the foam is formed from a composition in which the polystyrene has a molecular weight (M_{W}) of at least about 95% of the polystyrene in an identical composition without the flame retardant compound.

The present invention also contemplates a flame-retarded extruded polystyrene foam having a YI in the range of from about 1 to about 10 and containing as a flame retardant a compound having the structure: 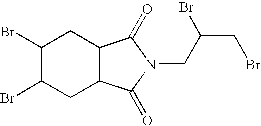
wherein the foam is substantially free of antimony trioxide.

The present invention further contemplates a method of producing flame-retarded extruded polystyrene foam substantially free of antimony trioxide, the method comprising providing a molten polystyrene resin, melt blending with the molten polystyrene from about 0.1 wt % to about 10 wt % of a flame retardant compound having the structure. 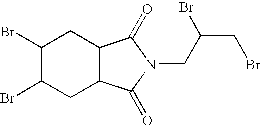
adding a blowing agent to the molten polystyrene to form a flame retardant polystyrene composition, and extruding the flame retardant polystyrene composition through a die thus forming an extruded polystyrene foam, wherein the average YI of said extruded polystyrene foam is in the range of from about 1 to about 10.

### DETAILED DESCRIPTION OF THE INVENTION

It should be noted that “foam” and/or “foams” is used interchangeably with “extrudable polystyrene foam compositions”, “extruded polystyrene foam compositions”, “extrudable polystyrene foams”, “extruded polystyrene foams”, “flame-retarded extrudable polystyrene foam compositions”, “flame-retarded extruded polystyrene foam compositions”, “flame-retarded extrudable polystyrene foams”, “flame-retarded extruded polystyrene foams, etc.

Also YI is used as an abbreviation for “Yellowness Index”, a method still used commonly as a value particularly useful for detecting variation among very white objects, such as polystyrene foams, despite having been withdrawn in 1995 by ASTM. The yellowness index measurement capabilities, YI D1925 [C/2], are readily available on commercial instruments such as HunterLab Instruments. It should be noted that when objects are being compared using the YI D1925 [C/2], they must be similar in transparency, opacity, thickness, shape, and other physical attributes.

The YI values given herein were obtained from a HunterLab ColorQUEST® XE Spectrometer (serial number: CQX2963) from Hunter Associates Laboratory, Inc., Reston, Va. using a 6.6 mm SAV (small area view) port aperture and a nominal diffuse/8° Sphere optical geometry, 10° Observer, D65 illuminant with a Didymium filter (78.12% transmission at 430 nm, 34.28% transmission at 570 nm). EasyMatch® QC software, version 3.61.00 (2004) was used to process the instrumental data. The data was processed for the 2 degree standard observer function and C illuminant for obtaining YI D1925 [C/2] values.

In this regard, the spectrometer instrument was calibrated using calibrated tile set HCL-405 in “reflectance—specular included” (RSIN) standardization mode. The small area view (SAV) was used, where the entire sample, cylindrical foams of about 1.5 cm in diameter and about 5 inches in length, covered the light emitting through the small aperture (hole diameter about 0.9 cm) of the external reflectance port. No sample cell or lens was used, and the UV filter was left out. The green tile (X=19.35, Y=25.44, Z=21.23, L*=57.50, a*=−22.42, b*=10.18; Illuminant D65, 10° Observer, ASTM E308) is standardized once/week, and the value is maintained at ±0.3 for X, Y, and Z.

The calibration procedure was as follows:
The cover plate (used for small area view) was installed at the external reflectance port.
To initiate calibration, the external reflectance port was covered with the black light trap, covering the area view, and was read by the detector.
The light trap was removed, and the reflectance port was covered with the white calibration tile (X=80.19, Y=85.05, Z=89.76, L*=93.90, a*=−0.87, b*=1.05; Illuminant D65, 10° Observer, ASTM E308, Serial No. CQX2963, Date Oct. 31, 2005) and read by the detector.

It should be noted that Dow's PS-168 (no flame retardant) may be used as a reference standard also, but similar values are obtained when white tile calibration is used, and a reference standard not used.

After calibration, the YI of foams were measured using cylindrical samples having the dimensions described above. The foam “rod” was held with and end-on view to completely cover the small area view at the external reflectance port. Three separate foam samples were independently measured three times (with or without using a standard PS-168 reference foam) and averaged to arrive at the values discussed herein. The results of these measurements show that the “FR” compound of this invention can be extruded with little color imparted to the foam, similar to the control material that is currently used in this XPS application.

The present invention is directed generally to extrudable polystyrene foam compositions having flame retardant properties, flame retardant extruded polystyrene foams, methods of making such foams, and products comprising such compositions and foams. According to one aspect of the present invention, a flame retardant extruded polystyrene foam composition comprises polystyrene and at least one flame retardant compound. Optionally, the composition may include one or more synergists, stabilizers, or various other additives.

The flame retardant compounds used in the foams of the present invention are compounds having the structure: 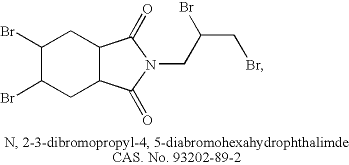
its automatic forms, stereoisomer's, and polymorphs (collectively referred to as “compound (I)”)

It has been discovered that use of compound (I) to form a flame retardant composition results in thermally stable and efficacious foam. Compound (I) is readily melt blended into the molten polystyrene resin to form a flame retardant composition. Unlike other compounds that tend to degrade during processing and diminish foam quality, compound (I) remains stable during processing and does not adversely affect formation of the polystyrene foam.

According to one aspect of the present invention, the flame retardant composition has an initial shear viscosity that decreases less than about 15% after about 32 minutes at 190° C. In another aspect, the foam may be formed from a composition having an initial shear viscosity that decreases less than about 10% after about 32 minutes at 175° C.

The foam may be formed from a composition in which the polystyrene has a molecular weight (M_{W}) of at least about 90% of polystyrene in an identical composition without the flame retardant compound. In one aspect, the foam is formed from a composition in which the polystyrene has a molecular weight (M_{W}) of at least about 95% of the polystyrene in an identical composition without the flame retardant compound.

Foams of the present invention have an average YI in the range of from about 1 to about 10, preferably in the range of from about 1 to about 5, more preferably in the range of from about 1 to about 3, most preferably in the range of from about 1 to about 2, and in exemplary embodiments, the foam has an average YI of 1.

Compound (I) is typically present in the foams of the present invention in the amount of from about 0.1 to about 10 weight (wt) %, based on the total weight of the foam. In one aspect, compound (I) is present in the foams of the present invention in an amount in the range of from about 0.3 to about 8 wt %, on the same basis. In another aspect, compound (I) is present in the foams of the present invention in an amount in the range of from about 0.5 to about 7 wt %, sometimes in the range of from about 3 to about 4 wt %, on the same basis. In yet another aspect, compound (I) is present in the foams of the present invention in an amount in the range of from about 1 to about 5 wt %, on the same basis. While various exemplary ranges are provided herein, it should be understood that the exact amount of the flame retardant compound used depends on the degree of flame retardancy desired, the specific polymer used, and the end of the resulting product.

The extruded foam of the present invention can be formed from a styrenic polymer. Styrenic polymers that may be used in accordance with the present invention include homopolymers and copolymers of vinyl aromatic monomers, that is, monomers having an unsaturated moiety and an aromatic moiety.

According to one aspect of the present invention, the vinyl aromatic monomer has the formula:
H₂C═CR—Ar
wherein R is hydrogen or an alkyl group having from 1 to 4 carbon atoms and Ar is an aromatic group (including various alkyl and halo-ring-substituted aromatic units) having from about 6 to about 10 carbon atoms. Examples of such vinyl aromatic monomers include, but are not limited to, styrene, alpha-methylstyrene, ortho-methylstyrene, meta-methylstyrene, para-methylstyrene, para-ethylstyrene, isopropenyltoluene, isopropenylnaphthalene, vinyl toluene, vinyl naphthalene, vinyl biphenyl, vinyl anthracene, the dimethylstyrenes, t-butylstyrene, the several chlorostyrenes (such as the mono- and dichloro-variants), and the several bromostyrenes (such as the mono-, dibromo- and tribromo-variants).

According to one aspect of the present invention, the monomer is styrene. Polystyrene is prepared readily by bulk or mass, solution, suspension, or emulsion polymerization techniques known in the art. Polymerization can be effected in the presence of free radical, cationic or anionic initiators, such as di-t-butyl peroxide, azo-bis(isobutyronitrile), di-benzoyl peroxide, t-butyl perbenzoate, dicumyl peroxide, potassium persulfate, aluminum trichloride, boron trifluoride, etherate complexes, titanium tetrachloride, n-butyllithium, t-butyllithium, cumylpotassium, 1,3-trilithiocyclohexane, and the like. Additional details of the polymerization of styrene, alone or in the presence of one or more monomers copolymerizable with styrene, are well known and are not described in detail herein.

The polystyrene typically has a molecular weight of at least about 1,000. According to one aspect of the present invention, the polystyrene has a molecular weight of at least about 50,000. According to another aspect of the present invention, the polystyrene has a molecular weight of from about 150,000 to about 500,000. However, it should be understood that polystyrene having a greater molecular weight may be used where suitable or desired.

The foams of the present invention optionally may include a synergist. Non-limiting examples of synergists suitable for use herein include dicumyl peroxide, ferric oxide, zinc oxide, zinc borate, and oxides of a Group V element, for example, bismuth, arsenic, phosphorous, and antimony. According to one aspect of the present invention, the synergist is dicumyl.

If the foams of the present invention include a synergist, the synergist generally may be present in the foam in any amount in the range of from about 0.01 to about 5 wt %, based on the total weight of the foam. In one aspect, the synergist is present in the foam in an amount in the range of from about 0.05 to about 3 wt %, sometimes in the range of from about 0.1 to about 1 wt %, on the same basis. In another aspect, the synergist is present in the foam in an amount in the range of from about 0.1 to about 1 wt %, on the same basis. In yet another aspect, the synergist is present in the foam in an amount in the range of from about 0.1 to about 0.5 wt %, on the same basis. In an exemplary embodiment, if a synergist is used in the foams of the present invention, the synergist the synergist is present in the foam in an of about 0.4 wt %, on the same basis.

The ratio of the total amount of synergist to the total amount of compound (I) may be in the range of from about 1:1 to about 1:7. According to one aspect of the present invention, the ratio of the total amount of synergist to the total amount of compound (I) is in the range of from about 1:2 to about 1:4.

However, while the use of a synergist is described herein, it should be understood that no synergist is required to achieve an efficacious flame retardant composition. Thus, according to one aspect of the present invention, the flame retardant compositions is substantially free of a synergist. According to yet another aspect of the present invention, the flame retardant composition is substantially free of antimony compounds. According to another aspect of the present invention, the composition includes a synergist, but is substantially free of antimony trioxide.

The foams of the present invention optionally includes a thermal stabilizer. Examples of stabilizers include, but are not limited to zeolites; hydrotalcite; talc; organotin stabilizers, for example, butyl tin, octyl tin, and methyl tin mercaptides, butyl tin carboxylate, octyl tin maleate, dibutyl tin maleate; epoxy derivatives; polymeric acrylic binders; metal oxides, for example, ZnO, CaO, and MgO; mixed metal stabilizers, for example, zinc, calcium/zinc, magnesium/zinc, barium/zinc, and barium/calcium/zinc stabilizers; metal carboxylates, for example, zinc, calcium, barium stearates or other long chain carboxylates; metal phosphates, for example, sodium, calcium, magnesium, or zinc; or any combination thereof.

If the foams of the present invention include a thermal stabilizer, it is generally present in an amount in the range of from about 0.01 to about 10 wt %, based on the total weight of compound (I) used in the foam. In one aspect, the thermal stabilizer is present in the foams of the present invention in an amount in the range of from about 0.5 to about 5 wt %, on the same basis. In yet another aspect, the thermal stabilizer is present in the foams of the present invention in an amount in the range of about 1 to about 5 wt %, on the same basis. In still another aspect, the thermal stabilizer is present in the foams of the present invention in the amount of about 2 wt %, on the same basis.

Other additives that may be used in the composition and foam of the present invention include, for example, extrusion aids (e.g., barium stearate and calcium stearate), or dicumyl compounds and derivatives, dyes, pigments, fillers, thermal stabilizers, antioxidants, antistatic agents, reinforcing agents, metal scavengers or deactivators, impact modifiers, processing aids, mold release agents, lubricants, anti-blocking agents, other flame retardants, other thermal stabilizers, antioxidants, UV stabilizers, plasticizers, flow aids, and similar materials. If desired, nucleating agents (e.g., talc, calcium silicate, or indigo) can be included in the polystyrene composition to control cell size.

Any suitable process known in the art can be used to form the foams of the present invention, and these foams can be used for numerous purposes including, but not limited to, thermal insulation.

One exemplary procedure for forming the foams of the present invention involves melting a polystyrene resin in an extruder thus forming a molten resin. The molten resin is transferred to a mixer, for example, a rotary mixer having a studded rotor encased within a housing with a studded internal surface that intermeshes with the studs on the rotor. The molten resin and a volatile foaming or blowing agent are fed into the inlet end of the mixer and discharged from the outlet end, the flow being in a generally axial direction. From the mixer, the gel is passed through coolers and from the coolers to a die that extrudes a generally rectangular board. Such a procedure is described for example in U.S. Pat. No. 5,011,866, incorporated by reference in its entirety. Other procedures, such as those described in U.S. Pat. Nos. 3,704,083 and 5,011,866, each of which is incorporated by reference herein in its entirety, include use of systems in which the foam is extruded and foamed under sub-atmospheric, atmospheric, and super-atmospheric pressure conditions. Other examples of suitable foaming processes appear, for example, in U.S. Pat. Nos. 2,450,436; 2,669,751; 2,740,157; 2,759,804; 3,072,584; and 3,215,647, each of which is incorporated by reference in its entirety.

Various foaming agents or blowing agents can be used to produce the flame retardant extruded polystyrene foam of the present invention. Examples of suitable materials are provided in U.S. Pat. No. 3,960,792, incorporated by reference herein in its entirety. Volatile carbon-containing chemical substances are used widely for this purpose including, for example, aliphatic hydrocarbons including ethane, ethylene, propane, propylene, butane, butylene, isobutane, pentane, neopentane, isopentane, hexane, heptane, or any mixture thereof; volatile halocarbons and/or halohydrocarbons, such as methyl chloride, chlorofluoromethane, bromochlorodifluoromethane, 1,1,1-trifluoroethane, 1,1,1,2-tetrafluoromethane, dichlorofluoromethane, dichlorodifluoromethane, chlorotrifluoromethane, trichlorofluoromethane, sym-tetrachlorodifluoroethane, 1,2,2-trichloro-1,1,2-trifluoroethane, sym-dichlorotetrafluoroethane; volatile tetraalkylsilanes, such as tetramethylsilane, ethyltrimethylsilane, isopropyltrimethylsilane, and n-propyltrimethylsilane, and any mixture thereof. One example of a fluorine-containing blowing agent is 1,1-difluoroethane, provided under the trade name HFC-152a (FORMACEL Z-2, E.I. duPont de Nemours and Co.). Water-containing vegetable matter such as finely-divided corn cob can also be used as a blowing agent. As described in U.S. Pat. No. 4,559,367, incorporated by reference herein in its entirety, such vegetable matter can also serve as a filler. Carbon dioxide also may be used as a blowing agent, or as a component thereof. Methods of using carbon dioxide as a blowing agent are described, for example, in U.S. Pat. No. 5,006,566; 5,189,071; 5,189,072; and 5,380,767, each of which is incorporated by reference herein in its entirety. Other examples of blowing agents and blowing agent mixtures include nitrogen, argon, or water with or without carbon dioxide. If desired, such blowing agents or blowing agent mixtures can be mixed with alcohols, hydrocarbons, or ethers of suitable volatility. See, for example, U.S. Pat. No. 6,420,442, incorporated by reference herein in its entirety.

The extruded polystyrene foam typically may include the various components and additives in the relative amounts set forth above in connection with the compositions used to form the foam. Thus, for example, an extruded polystyrene foam of the present invention may contain a flame retardant compound in an amount of from about 0.1 to about 10 wt % of the foam.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount. The following examples will illustrate the present invention, but are not meant to be limiting in any manner.

### EXAMPLES

In the following examples “PS” is used interchangeably for polystyrene.

### Example 1

the impact of extrusion on the molecular weight of various flame retardant concentrates and foams was determined by evaluating the samples using GPC before and after extrusion.

Sample A was prepared by making a concentrate (10 wt % compound I), and then letting the concentrate down into a neat resin at a ratio of about 35 wt % concentrate to about 65 wt % PS-168 neat resin and extruding low density foam via carbon dioxide injection. PS-168 is a general purpose non-flame retarded grade of reinforced crystal polystyrene commercially available from Dow Chemical Company. It has a weight average molecular weight of about 172,000 daltons and a number average molecular weight of about 110,000 daltons (measured by GPC). The molecular weight analyses were determined at THF with a modular Waters HPLC system equipped with a Waters 410 differential refractometer and a Precision Detectors model PD-2000 light scattering intensity detector. The columns used to perform the separation were 2 PL Gel Mixed Bed B columns (from Polymer Labs). Polystyrene standards, also from Polymer Labs, were used as calibration standards in the determination of molecular weight values.

The concentrate contained about 10 wt % compound (I), about 0.5 wt % hydroalcite thermal stabilizer, about 4.3 wt % Mistron Vapor Talc, about 1.5 % calcium stearate, and about 83.7 wt % Dow PS-168. The concentrates were produced on a Werner & Phleiderer ZSK-30 co-rotating twin screw extruder at a melt temperature of about 175° C. A standard dispersive mixing screw profile was used at about 250 rpm and a feed rate of about 8 kg/hour. PS-168 resin was fed via a single screw gravimetric feeder, and the powder additives were pre-mixed and fed using a twin screw powder feeder.

The concentrate was then mixed into neat Dow polystyrene PS-168 using the same twin screw extruder at a ratio of about 35 wt % concentrate to about 65 wt % polystyrene to produce foam using the following conditions: temperatures of Zones 1 (about 175° C.), 2 (about 160° C.), 3 (about 130° C.), and 4 (about 130° C.), about 145° C. die temperature, about 60 rpm screw speed, about 3.2 kg/hour feed rate, 40/80/150 screen pack, from about 290 to about 310 psig carbon dioxide pressure, about 160° C. melt temperature, from about 63 to about 70% torque, and from about 2 to about 3 ft/minute takeoff speed.

The foam contained about 3.5 wt % flame retardant (about 2.2 wt % bromine), and about 1.5 wt % talc as a nucleating agent for the foaming process. DHT4A hydrotalcite in an amount of about 5 wt % of the flame retardant compound was also used to stabilize the flame retardant during the extrusion and foam-forming process. A standard two-hole stranding die (⅛ inch diameter holes) was used to produce the foams, with one hole plugged. The resulting ⅝ inch diameter foam rods had a very thin surface skin (0.005 inches or less) and a fine closed cell structure. Carbon dioxide gas was injected into barrel #8 (the ZSK-30 is a 9-barrel extruder). The rods were foamed with carbon dioxide to a density of about 9.0 lbs/ft³ (0.14 specific gravity).

Control sample K was prepared as in Sample A, except that the concentrate contained about 9 wt % SAYTEX® HP900SG stabilized hexbromocyclododecane (HBCD).

Comparative sample L was prepared by making a PS-68 resin concentrate containing about 13 wt % compound (II), N-methyl-isoindole-1,3-(2H)-dione, 5,6-dibromohexahydro-Cas. No. 2021-21-8, about 0.5 wt % calcium stearate, and about 80.7 wt % Dow PS-168.

The concentrate was produced on a Werner & Phleiderer ZSK-30 co-rotating twin-screw extruder at a melt temperature of about 175° C. A standard dispersive mixing screw profile was used at about 250 rpm and a feed rate of about 8 kg/hour. PS-168 resin concentrate and powder additives were pre-mixed and fed via a single screw gravimetric feeder. The concentrate ran poorly, turning dark orange over time. Off-gassing occurred, with loss of resin melt strength. Standing became impossible after about 10 minutes of extrusion.

Comparative sample M was prepared by making a PS-168 resin concentrate containing about 12.5 wt % compound (III), 1H-isoindole-1,3(2H)-dione, 5,6-dibromohexahydro, CAS No 59615-06-4, about 0.5 wt % hydrotalcite thermal stabilizer, about 4.3 wt % Mistron Vapor Talc, about 1.5 wt % calcium stearate, and about 81.2 wt % Dow PS-168.

The concentrate was produced on a Werner & Phleiderer ZSK-30 co-rotating twin screw extruder at a melt temperature of about 175° C. A standard dispersive mixing screw profile was used at about 250 rpm and a feed rate of about 8 kg/hour. PS-168 resin concentrates and powder additives were pre-mixed and fed via a single screw gravimetric feeder. The concentrate ran reasonably well in terms of maintaining melt strength and good stranding, but the material turned dark red-orange from the outset. Initial off-gassing stabilized after about 5-10 minutes.

Sample N was prepared as described above in reference to Sample A except that 30 wt % compound (IV), Brominated bis-1,1′-(methylenedi-4,1-phenylene)bismaleimide, was used instead of compound (I).

The concentrate contained about 30 wt % (1.11 kg) compound (IV) and about 70 weight % (2.59 kg) PS-168. The concentrate was produced on a Leistritz/Haake Micro 18 counter-rotating twin screw extruder at a melt temperature of about 170° C. A standard dispersive mixing screw profile was used at about 100 rpm and a feed rate of about 3 kg/hour. The polystyrene resin concentrate and the powder additives were pre-mixed and fed using a single-screw gravimetric feeder. The extruded strands exhibited slight foaming and odor, indicative of thermal release of Hbr.

TABLE 1

| | | | MW, after | |
|---|---|---|---|---|
| | | MW, initial | extrusion | Differ- |
| Sample | Description | (Daltons) | (Daltons) | ence |
| A-conc | Polystyrene/Compound I | 172,000 | 164,000 | −5% |
| K-conc | Polystyrene/HP-900SG | 172,000 | 166,000 | −3% |
| L-conc | Polystyrene/compound II | 172,000 | 177,400 | +3% |
| M-conc | Polystyrene/compound III | 172,000 | 176,700 | +3% |
| N-conc | Polystyrene/compound IV | 240,000 | 120,000 | −50% |
| PS-168 | Polystyrene | 172,000 | 171,000 | −1% |

The results indicate that compound (I) is highly stable and causes minimal, if any, degradation of the polystyrene. In contrast, compound (IV) causes significant degradation of the polystyrene and is, therefore, not suitable for producing a flame retardant extruded polystyrene foam.

### Example 2

A Hunter Lab ColorQUEST Spectrocolorimeter (diffuse geometry) was used to measure the Yellowness Index (YI) value for various flame retardant foams. The procedure used was that described above in the “Detailed Description of the Invention” section.

Samples A, K, L, M, N and PS-168 are described above. The results are presented in Table 6.

TABLE 2

| Type | Description | Sample | YI | Color |
|---|---|---|---|---|
| Foam | Compound | A-foam | 1 | White |
| | I/PS | | | |
| | HP- | K-foam | 1 | White |
| | 900SG/PS | | | |
| | Compound | L-foam | 57 | Orange |
| | II/PS | | | |
| | Compound | M-foam | 64 | Dark |
| | III/PS | | | orange |
| | Polystyrene | PS-168 | 1 | white |
| | foam | | | |

The results indicated that compound (I) is highly suitable for use in forming a polystyrene foam. The lack of color change is demonstrative of high thermal stability with little or no polymer degradation. Samples L-foam and M-foam have significant coloration that render the flame retardant compounds (II) and (III) unsuitable for forming extruded polystyrene foams.

What is claimed:

1. A flame-retarded extruded polystyrene foam containing a flame retardant compound having a structure: 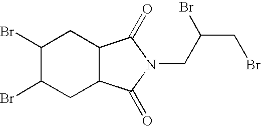
wherein the average YI of said flame-retarded extruded polystyrene foam is in the range of from about 1 to about 10 and the flame retarded extruded polystyrene foam has a molecular weight (M_{W}) of at least about 90% of the polystyrene in an identical composition without the flame retardant compound.

2. The extruded polystyrene foam of claim 1, wherein the flame retardant compound is present in an amount of from about 0.1 to about 10 wt % of the foam.

3. The extruded polystyrene foam of claim 1, wherein the flame retardant compound is present in an amount of from about 0.5 to about 7 wt % of the foam.

4. The extruded polystyrene foam of claim 1, wherein the flame retardant compound is present in an amount of from about 1 to about 5 wt % of the foam.

5. The extruded polystyrene foam of claim 1, wherein the flame retardant compound is present in an amount of from about 3 to about 4 wt % of the foam.

6. The extruded polystyrene foam of claim 1, formed from a composition having an initial shear viscosity that decreases less than about 15% after about 32 minutes at 190° C.

7. The extruded polystyrene foam of claim 1, formed from a composition having an initial shear viscosity that decreases less that about 10% after about 32 minutes at 175° C.

8. The extruded polystyrene foam of claim 1, formed from a composition in which the flame-retarded extruded polystyrene has a molecular weight (M_{W}) of at least about 95% of the polystyrene in an identical composition without the flame retardant compound.

9. The extruded polystyrene foam of claim 1, having an average YI of from about 1 to about 5.

10. The extruded polystyrene foam of claim 1, having an average YI of about 1.

11. An article made from the extruded polystyrene foam of claim 1.

12. The extruded polystyrene foam of claim 11, wherein said article is thermal insulation.

13. A flame-retarded extruded polystyrene foam having an average YI in the range of from about 1 to about 10, said flame-retarded extruded polystyrene foam having at least one of the following characteristics:
(a) the foam is formed from a composition having an initial shear viscosity that decreases less than about 15% after about 32 minutes at 190° C.;
(b) the foam is formed from a composition having an initial shear viscosity that decreases less than about 10% after about 32 minutes at 175° C.;
(c) the foam is formed from a composition in which the polystyrene has a molecular weight (M_{W}) of at least about 90% of the polystyrene in an identical composition without the flame retardant compound; or

14. The extruded polystyrene foam of claim 13, wherein the flame retardant compound is an aliphatic brominated compound, a cycloaliphatic compound, or a combination thereof.

15. The extruded polystyrene foam of claim 13, wherein the flame retardant compound is:

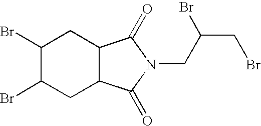

16. An extruded polystyrene foam containing a flame retardant compound having the structure: 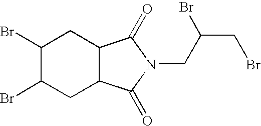
wherein the extruded polystyrene foam is substantially free of antimony trioxide and has an average YI in the range of from about 1 to about 10 and the flame retarded extruded polystyrene foam has a molecular weight (M_{W}) of at least about 90% of the polystyrene in an identical composition without the flame retardant compound.

17. A method of producing flame-retarded extruded polystyrene foam substantially free of antimony trioxide, the method comprising:
providing a molten polystyrene resin;
melting blending with the molten polystyrene from about 0.1 wt % to about 10 wt % of a flame retardant compound having the structure: 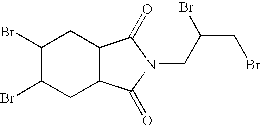
adding a blowing agent to the molten polystyrene to form a flame retardant polystyrene composition; and
extruding the flame retardant polystyrene composition through a die thereby forming a extruded flame retarded polystyrene foam substantially free of antimony trioxide, wherein the average YI of said flame retarded polystyrene foam substantially free of antimony trioxide is in the range of from about 1 to about 10.

18. The method according to claim 17 wherein the flame retarded extruded polystyrene foam has a molecular weight (M_{W}) of at least about 90% of the polystyrene in an identical composition without the flame retardant compound.
